(19) United States
(12) Patent Application Publication
(10) Pub. No.: US 2024/0346783 A1
(43) Pub. Date: Oct. 17, 2024

(54) REAL-TIME FIDUCIALS AND EVENT-DRIVEN GRAPHICS IN PANORAMIC VIDEO

(71) Applicant: COSM INC., Dallas, TX (US)

(72) Inventors: Brian C. Lowry, Emlenton, PA (US); Evan A. Wimer, Butler, PA (US); Philippe D. Hall, McCandless, PA (US); David R. Fischer, Pittsburgh, PA (US); Stephen Ziegenfuss, Jackson, MI (US)

(21) Appl. No.: 18/748,542

(22) Filed: Jun. 20, 2024

Related U.S. Application Data
(63) Continuation-in-part of application No. 18/264,860, filed on Aug. 9, 2023.
(60) Provisional application No. 63/148,424, filed on Feb. 11, 2021.

(51) Int. Cl. G06T 19/00; H04N 5/268; H04N 5/272

(52) U.S. Cl. CPC G06T 19/006; H04N 5/268; H04N 5/272

(57) ABSTRACT

A method and system are described where graphics, for example, fiducials, are placed within the context of panoramic video footage such that those graphics convey meaningful and relevant information, such as first down lines, sidelines, end zone plane (American football), three-point line (basketball), goal line (hockey, soccer), blue line (hockey), positional environmental, or biometric information. Graphics may also signify the status of event, such as whether a first down was made or whether a play was overturned. The system includes one or more cameras connected to a computer that also receives synchronized sensory data from one or more environmental or positional sensors. The fiducials may be based upon the content and context of the video, or augmented via the use of external sensors which may be aggregated by the computer, with graphics being generated and displayed on a frame-by-frame basis for the purposes of disseminating information and enhancing the live production.

### CROSS REFERENCE TO RELATED APPLICATION

This application is a continuation-in-part of U.S. patent application Ser. No. 18/264,860, entitled “REAL-TIME FIDUCIALS AND EVENT-DRIVEN GRAPHICS IN PANORAMIC VIDEO”, filed on Aug. 9, 2023, which is a national phase application of PCT Application Serial No. PCT/US2022/015989 filed on Feb. 10, 2022, which claims priority to U.S. Provisional Application Ser. No. 63/148,424, entitled “REAL-TIME FIDUCIALS AND EVENT-DRIVEN GRAPHICS IN PANORAMIC VIDEO”, filed on Feb. 11, 2021, all of which are incorporated by reference in their entirety.

### BACKGROUND

For over twenty years, sports enthusiasts have benefited from seeing the “1st and Ten” line in American football. The technology was originally developed independently by Sportsvision and PVI Virtual Media Services in the late 1990's, debuting in ESPN's® coverage of a Cincinnati Bengals-Baltimore Ravens game on Sep. 27, 1998. ESPN is a registered trademark of ESPN, Inc. in the United States and other countries.

### BRIEF SUMMARY

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates a block diagram of the invention apparatus.

FIG. 2A illustrates principles involved in image capture.

FIG. 2B illustrates an example of FIG. 2A.

FIG. 3 illustrates a means for determining object locations in a football field.

FIG. 4 illustrates a video frame with a LTG fiducial.

FIG. 5 illustrates a non-contiguous succession of video frames with graphics generated in response to field-object sensors.

FIG. 6 illustrates a means for creating personalized immersive camera experiences from a plurality of game cameras, via the Internet.

FIG. 7 illustrates an example inside view of a pylon.

FIG. 8 illustrates an example front view of pylon having a cutout for the camera lens.

FIG. 9 illustrates an example inside side view of a pylon having a cutout for the camera lens.

FIG. 10 illustrates an example top view of a pylon having a cutout for the camera lens.

FIG. 11 illustrates an example interior front view of a pylon.

FIG. 12 illustrates an example interior back view of a pylon.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

Traditional systems use a calibrated 3D model of the sports field, in conjunction with multiple cameras, and computers for each of those cameras. At its heart, it relies on a video technique called chromakeying. This is the familiar “green screen” technique used in broadcast weather forecasts. In the studio, the background is an empty, mono-color canvas, while a computer composites or “pastes” the picture of the weather map over the colored background.

Using the chromakeying technique, placing graphics, for example, the first down line, on a live event image is more complicated to implement due to the center crown of the field which exists to drain water. Thus, a complex laser alignment system is employed for modelling the playing field geometry. This is done for each and every playing surface, albeit typically once per playing season. Additionally, due to the nature of chromakeying, difficulties occur when the player's uniforms contain green or are otherwise similar to the “screen”. Likewise, varying colors of grass or turf can cause problems. In instances where the player's uniforms contain colors similar to the turf, those sections of the uniforms will “disappear” during the chromakeying process.

Another limitation of this system is that it can only be done with pre-calibrated cameras. Other limitations involve the personnel requisite for implementation. Typically, in live event production, graphics are inserted towards the end of the production pipeline. All camera views are ingested into the production backhaul and displayed in the production center, where the producer calls out the camera(s) that is to go live. The cadre of production operators insert pre-designed graphics combined with real-time statistics and customized computer software to produce the final, televised video.

As the live events production industry reacts to industry changes requiring fewer personnel in the field, what is needed is a means by which production-level graphics can be used to augment the event coverage, thus increasing entertainment value. Moreover, lower-tier events, such as college and secondary school events which do not garner the production budgets of professional sports, can benefit from this invention.

As legalized betting gains momentum in conjunction with televised and streamed sports, what is needed in the industry are superior means for adjudicating plays, referee calls, and outcomes. By combining camera capture with the ability to augment with real-time fiducials, outcomes may be more quickly discerned.

More details regarding object tracking, data aggregation, generation of objects in panoramic video, and sharing experiences in panoramic video can be found in Applicant's previously issued U.S. Pat. No. 10,094,903 titled “Object tracking and Data Aggregation in Panoramic,” U.S. Pat. No. 9,588,215 titled “Object tracking and Data Aggregation in Panoramic Video,” U.S. Pat. No. 10,623,636 titled “Generating Objects in Real Time Panoramic Video,” and U.S. Pat. No. 10,638,029 titled “Shared Experiences in Panoramic Video.” The details contained in these patents is incorporated by reference herein, as if they were set forth in their entirety.

Bender et al. (U.S. Patent Application Publication No. 2014/0063260) discloses a pylon-centric replay system consisting of three high-definition cameras, facing in such angles so as to capture substantially a 180° wide angle view of the field, including side and goal lines.

Halsey et al. (Admiral LLC in U.S. Pat. No. 10,394,108 B2) discloses a corner-oriented pylon variant that reduces the camera density, but offers the same wide angle. This pylon's camera is connected to the broadcast backhaul via a video transmission cable-typically coaxial or fiber optic.

In July 2019, Applicant, C360 Technologies, demonstrated, under the auspices of ESPN, an improved pylon that uses a single optic, single sensor solution that further reduced the pylon camera count while providing both wide angle view and superior video quality. Moreover, due to integral wireless transmission, the pylon could be moved readily around the field, and as such was suitable for use in the line to gain (LTG) marker. Coupled with this innovation is the ability to produce complex replay scenarios due to the fact that the camera is capturing and recording video from a substantially hemispherical field of view which captures the entire playing field, including sidelines, from the point of view of the camera. The invention disclosed herein purports to augment the state of the art with real-time, event-based fiducials and graphics.

Additionally, the pylon includes a physical laser that allows for the display of a physical laser line. In other words, the physical pylon includes a physical laser that can be activated to create a laser line that can be visibly seen by a person in the area of the pylon. It should be noted that while the term pylon will be used here throughout, this term is not intended to limit the scope of this disclosure to only a traditional sports pylon, for example, one that may be found in American football. In other words, the term pylon is not intended to take on its ordinary meaning and is instead intended to encompass not only traditional pylons, but also any other marker, stick, and/or the like, that is used to identify and/or indicate a spot or location on a playing surface. Thus, the systems and methods disclosed herein could be applied to any application where the described system could be implemented. For example, in one application, the physical laser can be added to the first down marker, or signal pole, that is moved throughout the game to identify where the current mark is to reach a first down and/or the line of scrimmage. As another example, the physical laser may be added to a pylon delineating the end zone. It should be also noted that while American football will be the example used throughout, the described system and method can be applied to other sports, for example, rugby, soccer, tennis, pickle ball, basketball, and/or the like.

The physical laser that is added to the pylon allows for the presentation of a physical laser line. This laser line can be used by the crew or people who are associated with the pylon to properly line up the pylon with the correct location. For example, when a first down occurs on the field of play, the chain crew (i.e., the people responsible for the movement and marking of the first down and line of scrimmage locations) moves the first down marker unit, which is generally made up of three signal poles and a chain connecting the front signal pole with the back signal pole and having a distance of 10 yards. The third signal pole is used to designate the line of scrimmage that generally moves after every play or penalty. This line of scrimmage pole is not physically connected to the other two signal poles. After a first down, the person in charge of the back pole moves the back signal pole to line up with the current location of the football, this is also the line of scrimmage. The person in charge of the front pole moves ahead (with respect to the direction of play) of the back pole until the chain is taut, thereby marking the next first down point 10 yards down the field.

The back pole person has to line up the pole with the location of the football and generally uses field markers to assist in determining the correct location. However, since the football is usually located within the field of play and the chain crew is located along the sidelines, this marking may not be completely accurate since it relies on marks along the field and individual observation. Accordingly, with the use of the physical laser line as described herein, the person can illuminate the laser, line it up with the football, and then line up the marker in line with the football, thereby making a more accurate first down marking. Additionally, a computer system can utilize the physical laser line to verify any virtual objects that are placed within a video feed that is seen by viewers watching a sporting game. In other words, the computer system places virtual objects, for example, a first down marker, a line of scrimmage, three-point line, lines to gain, and/or the like, within the video feed. Utilizing the physical laser which has been illuminated by the first down marker team, the system can verify that the location of the virtual objects within the video feed are the correct locations.

For a better understanding of the embodiments, together with other and further features and advantages thereof, reference is made to the following description, taken in conjunction with the accompanying drawings.

The description now turns to the figures. The illustrated embodiments of the invention will be best understood by reference to the figures. The following description is intended only by way of example and simply illustrates certain selected exemplary embodiments of the invention as claimed herein.

It should be noted that the block diagrams in the figures illustrate the architecture, functionality, and operation of possible implementations of systems, apparatuses, methods and computer program products according to various embodiments of the invention. In this regard each block in the block diagram may represent a module, segment, or portion of code, which comprises at least one executable instruction for implementing the specific logical function(s). It should also be noted that, in some alternative implementations, the functions noted in the block diagram might occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and combinations of blocks in the block diagram can be implemented by special purpose hardware-based systems that perform the specified functions or acts, or combinations of special purpose hardware and computer instructions.

While the example of a sporting event will be used here throughout to provide ease of understanding, it should be understood that the described system and method is not limited to simply providing graphic overlays onto sporting event images. Rather, the described system and method can be implemented in a variety of “live-image” feed situations, for example, news coverage, distance learning environments, medical environments, augmented or virtual reality environments, or the like. Thus, the description herein is not to be construed as limiting the described system to sporting events and it is easily understood from the description herein how the described system and method can be applied to other use cases, applications, or technologies.

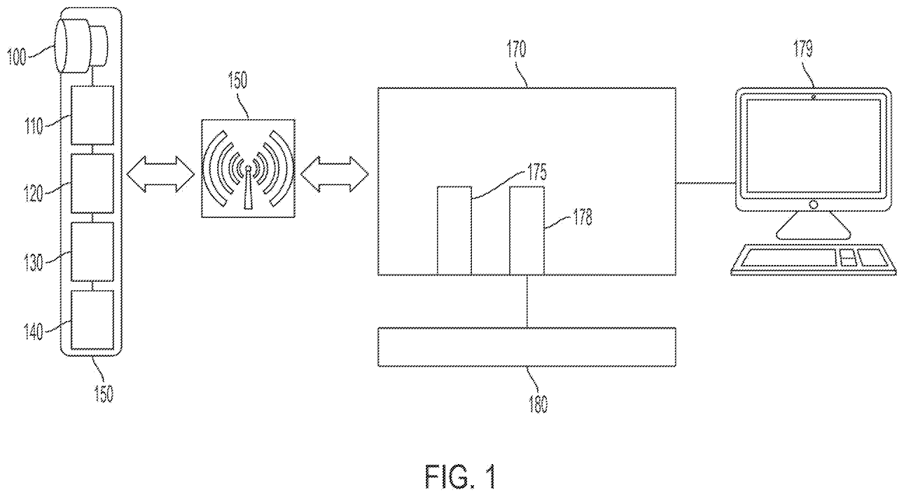

FIG. 1 depicts a block diagram of the devices and components in one embodiment of this invention. In this embodiment, a camera (100), sensors (110), embedded processor (120), transmission device (130) and battery (140) are co-located in a pylon (150). The pylon in this embodiment is a National Football League (NFL®) or National Collegiate Athletic Association (NCAA®) specified pylon, with dimensions of ˜18″ in height, ˜5″ in both width and depth for Line to Gain and ˜18″ in height, ˜4″ in both width and depth, for end zone and suitably constructed with foam and composite plastic materials such that it is lightweight, thereby minimizing or eliminating injury to the players or other people if it were to be struck in the course of game action. These pylons are used to mark the field of play, and are required to be located in both end-zone front and back corners, as well as the first down line. Whereas the end zone pylons are stationary, the first down line changes during the course of the game, and as such must not be encumbered by power or video transmission wires. Thus, the pylons may either be wired or wireless pylons. NFL is a registered trademark of NFL Properties LLC in the United States and Other Countries. NCAA is a registered trademark of National Collegiate Athletic Association in the United States and other countries.

The unwired or wireless pylons use radio transmitters or other transmitters to transmit the video from the pylon to the processing devices. Different transmitters and/or components may be used in different applications and the chosen transmitters and/or components may be based upon a location of the device that will process the video captured by the imaging components of the pylon. For example, the pylon may include components that allow connection to and communication with cloud storage devices and components, remote storage devices and components, local storage devices and components, and/or the like. Transmissions may be performed using one or more of near-field communication, short-range communication, network communication, telecommunication networks, and/or the like, or a combination thereof.

The wired pylons include wires that can be utilized for transmission of data from the pylon to a processing device. In some cases, it may be useful to use wires for some connections and wireless transmissions for other connections. For example, the wired pylon may include a power wire but may transmit data using a wireless connection. While the wired pylons are stationary to the point that they are not purposely moved throughout the play of an event, the wired pylons may be subject to forces that cause them to move, such as a player, other individual, or event object hitting the pylon. Thus, the wired pylons may be equipped with break-away connectors. These connectors allow for the connection of the wires to the pylon, but if the pylon is hit or otherwise dislodged, the connectors will uncouple without breaking or pulling the wires from either the pylon or the other portion of the connector.

Additionally, since the pylon may be dislodged and may, therefore, become unwired, the pylon may include components that allow for the pylon to remain functional even when disconnected from the wires. For example, the pylon may include a battery to provide backup power, storage to provide an on-board data storage location, and/or the like. Thus, even when disconnected from the wires, the pylon can still capture and store a video feed, at least for a short time until the pylon is reconnected to the connector.

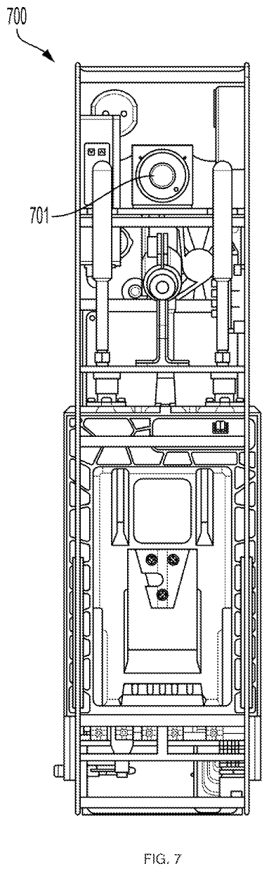

The pylon includes a camera, for example, as shown in FIG. 7 at 702. FIG. 7 illustrates an example pylon without the outer protective covering. In other words, FIG. 7 illustrates an example interior front view of the pylon. The camera (100) may be a broadcast-quality camera with such attributes as to allow it to be aired live during the game as well as via replay. These attributes include large dynamic range (typically >64 dB), high resolution, global shutter, 10-bit 4:2:2 chroma subsampling, and nominally 60 frames per second (fps). As broadcast-quality cameras improve, the new technology can be utilized with the described system to provide even better broadcast capabilities. In the example embodiment, the camera utilizes a “fisheye” lens with a field of view such that the sidelines are captured by the camera. This assists in capturing plays for the purpose of adjudicating referee calls, e.g., whether a player's foot was in or out of bounds, etc. Thus, the horizontal field of view is nominally 180°. An example lens may be a dioptric 4 mm f/2.8 lens which gives the camera a 210° horizontal field of view. However, other horizontal fields of view may be possible using different lenses and/or technology.

In one embodiment, the pylon may include a cutout that allows for the field of view provided by the camera to be actually obtained. Since the camera is located in an object that may be hit, thrown, and/or otherwise subject to harsh treatment and/or harsh environmental conditions (e.g., wind, rain, snow, heat, etc.), the camera may be located within the pylon so that the pylon can provide some cushioning or protection for the camera. However, by putting the camera within the pylon in a position that helps protect the camera, the lens is no longer on the same plane of the face of the pylon or protruding from a face of the pylon. This means that even though the camera could have a wide field of view, it will not actually be useful because the outer portions of the field of view would capture the inside of the pylon. Accordingly, in one embodiment, the pylon includes a cutout that allows for the lens to capture the wide field of view of the playing field and not the inside of the pylon. Thus, the camera can be placed inside the pylon in a manner that provides protection to the camera, but the wide field of view afforded by the lens can still be utilized to capture more of the playing field or environment, instead of the inside of the pylon.

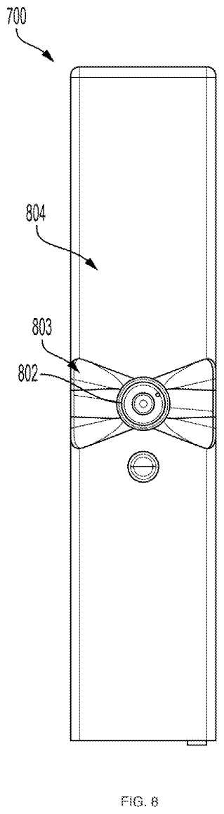

An example of this cutout is illustrated in FIGS. 8-10. FIG. 8 illustrates a front view of an example pylon 700 having a camera lens 802. As compared to FIG. 7, FIG. 8 illustrates the pylon 700 having the protective pylon covering. In other words, while FIG. 7 illustrates an internal view of the pylon, FIG. 8 illustrates an external view of the pylon.

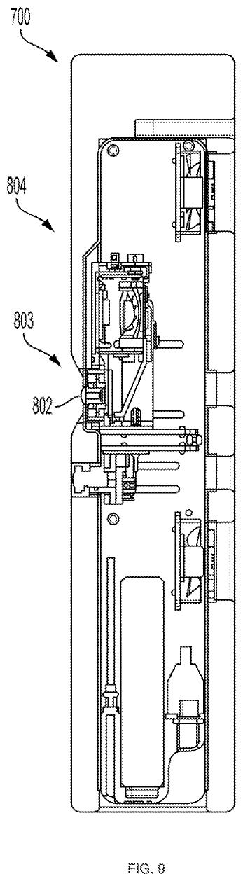

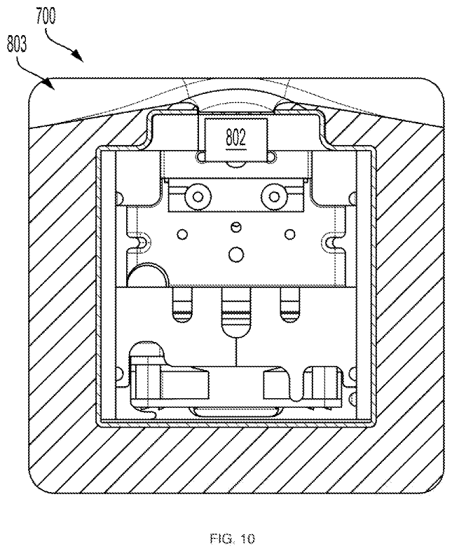

In order to capture the wide field of view obtainable using the camera lens, the pylon 700 includes a cutout 803. The cutout allows light from the extreme (greater than 180 degree horizontal field of view) to be received by the lens and directed onto the optic. As discussed in more detail below, the light from the lens is directed onto an imaging sensor to capture an image of the scene. Thus, the greater the field of view with respect to the light that can be captured by the lens, thereby providing a scene having a greater field of view. FIG. 9 illustrates an inside side view of the example pylon 700. As can be seen from this side view, the camera lens 802 is inset as compared to the face 804 of the pylon 700. As previously mentioned, this helps protect the camera. As can also be seen from this side view, the cutout 803 provides a relief that allows for the field of view obtainable by the camera to actually be captured. FIG. 10 illustrates a cutoff top view of the pylon 700. As can be seen in this view the cutout 803 extends behind the camera lens 802 so that a piece of the pylon is not in the field of view of the lens 802.

In addition to the cutout, the camera or camera lens may be on a carriage that allows for an amount of protrusion of the optic or lens to be changed. In other words, the system can adjust the location of the optic or lens so that it protrudes more or less from the pylon, thereby adjusting the field of view that can be captured by the camera. The cutout and the carriage can be used to help achieve a very wide angle of field of view while also protecting the camera or lens to some extent.

In one embodiment, a sensor array (110) may be utilized. The purposes of the sensor(s) is to inform the embedded processor (120) of the orientation and position of the pylon as it relates to the playing field. In this embodiment, an embedded processor (120) aggregates information from the positional sensors (110) and synchronizes this information with the video stream.

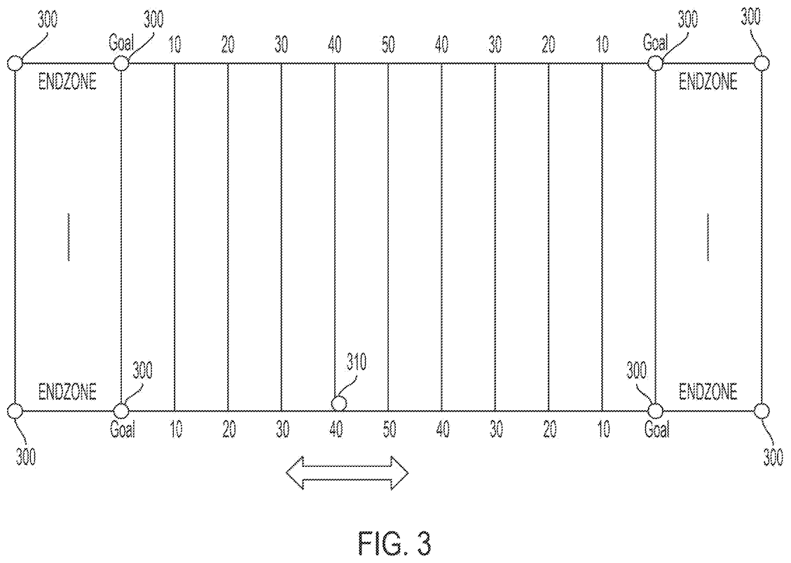

FIG. 3 shows a schematic of an American football field. Using Real Time Location Services (RTLS) technology we can accurately determine the location of the pylon as it traverses the field of play. The RTLS technology relies on sensors included in the pylon, which can move, and stationary sensors which act as anchor points. The anchor points have known locations. Since the pylons can move, the location of the pylon can change. However, based upon communications between the pylons and the anchor points, the location of the pylons can be identified.

Stationary anchor transducers (300) are located in the corners of the field, either in the pylons, or beneath the turf. In one embodiment, the anchors may be Ultra-Wide Band (UWB) transceivers. These battery-powered units may communicate in the 6.5 GHz channel with a sensor (110) which is located in the pylon (310/150). The communication channel or frequency may be changed based upon different applications that the transceivers and/or sensors are used within. The pylon sensor is capable of producing multiple information streams, including sensing motion, relaying pylon position relative to the anchors (300) with accuracy to within 10 cm, as well as pylon orientation via an on-board 3-axis accelerometer. This information is ingested by the embedded processor (120) at 10's to 100's of Hz, with higher frequencies negatively impacting battery (140) life for the benefit of faster response times. UWB is a well-established means for RTLS, and is an IEEE standard (15.4-2011). Moreover, it operates over ranges useful and necessary for field sports (300 m). It should be noted that regardless of the sensor type, it may be polled at frequencies different from the video capture frequency. For example, a UWB position may be updated at 10 Hz, while the camera captures at 60 Hz. This will be reflected in the metadata synchronized with each vide frame.

Returning to FIG. 1, in one embodiment, the embedded processor may be a System on a Chip (SoC) design that combines a multi-core CPU, Graphics Processing Unit (GPU), unified system memory with multiple standard I/O interfaces, including i2c, USB, Ethernet, GPIO, and PCIe. These small, ruggedized units are designed to withstand the environmental extremes found in out-of-doors events. Furthermore, they are cable of encoding multiple 4k (4×HD resolution) 60 fps streams concurrently with very low latency (<100 ms). Other embodiments may include other chip designs, processing units, and/or the like.

Other potential sensors (110) may include, but are not limited to, proximity sensors, environmental sensors (temperature, humidity, moisture), and Time of Flight (ToF) sensors, which may be used to accurately determine the distance of objects from the sensor. Other sensors may also be utilized to determined a distance an object is from an anchor position or other sensor having a known location. Additionally, depending on the sensors that are utilized, different distance/location algorithms may be utilized to determine a position or location of an object with respect to another object. For example, time of flight algorithms, angle of arrival algorithms, received signal strength indicator algorithms, time distance of arrival algorithms, and/or the like, and/or a combination thereof. Different distance and/or position calculations may require different sensors. Additionally, audio microphones may be used to capture sounds in the vicinity of the pylon. Later in this description, we will provide examples in which these sensors can be used to augment the live broadcast and replay.

The pylon (150) also contains a radio transceiver (130) which is used to wirelessly communicate (160) the video and sensor stream to a production workstation (170). Any radio technology capable of supporting sustained average (constant or adaptive) bitrates greater than 20 Mb/s is viable. These technologies may include “WiFi” (802.11 variants), cellular transmission via 4G LTE, 5G, and/or the like. A battery (140) provides power for the camera, sensor array, embedded processor, and radio transceiver. Ideally, the battery will last the course of the game, but this is not specifically required. Additionally, in the case that a pylon is stationary, the pylon may be wired and not include a battery, instead operating using wired power and include components for operating using the wired power. Alternatively, the pylon may include components for operating using more than one power source, for example, battery, wired power, other power sources (e.g., solar power, motion power, etc.), and/or the like.

Typically, the production workstation (170) is located in an Outside Broadcast (OB) truck in a media complex adjacent to, or in the vicinity of, the sporting event, although remote (REMI) productions are becoming more commonplace. Due to the high frame rate and high resolution video processing, much of the computational effort is accomplished on the workstation's GPU (175). Different GPUs may be utilized in the described system. The nature of these computations will be discussed below.

The workstation (170) may be controlled by a human operator via mouse, keyboard, monitor, or bespoke controller device optimized for quickly framing replays. During the course of a live event, the producer may elect to “go live” with the transmitted pylon camera feed. Alternatively, the operator may produce replay segments which are a succession of video frames highlighting a particular play or event. Replayed video segments are often played at a slower frame rate, allowing the viewers to discern more detail in the replayed event. Whether “live” or via replay, video frames processed via the workstation are pushed to the backhaul (180) where they may be used for the production. The broadcast industry has adopted numerous SMPTE (The Society of Motion Picture and Television Engineers) standards such as the Serial Digital Interface (SDI) which specifies an uncompressed, unencrypted audio/video data stream. A PCIe interface card (178) is used to convert each successive video frame, in GPU (175) memory, into its respective SDI video frame.

It should be noted that the described components are merely example components that may be used within the system. However, other components may additionally or alternatively be used, particularly as the technology becomes more sophisticated. Additionally, the components may be located in different physical locations and/or processing devices. The system may also make use of cloud computing environments and resources, remote computing environments and resources, and/or local computing environments and resources.

Having discussed the major components in the present embodiment, let us turn our attention to the workflow and resultant outcomes.

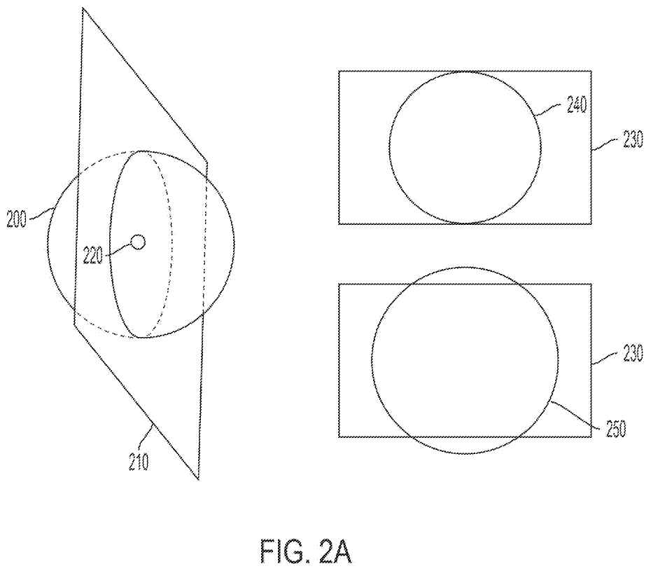

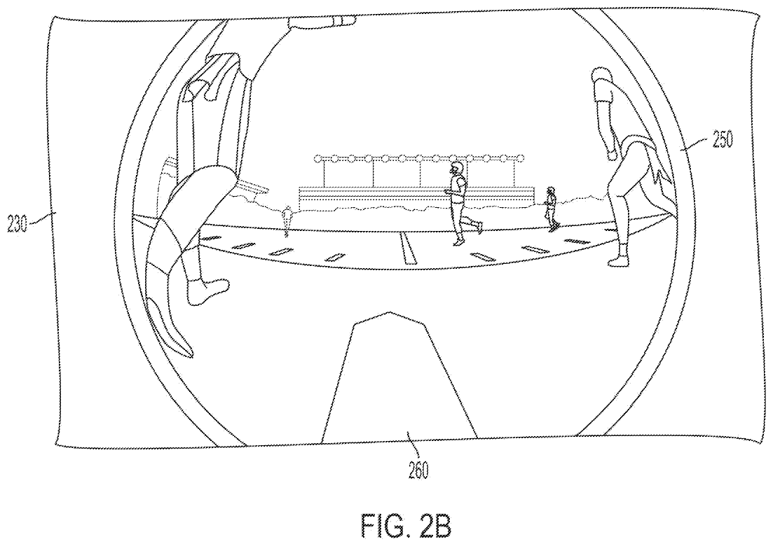

FIG. 2A is instructive in helping to understand concepts involved in capturing panoramic video. A sphere (200) is bisected by a plane (210). Let us imagine an observer (220) located at the center (origin) of the sphere. In the present embodiment, the camera is located at the observer's position, with the optic axis orthogonal to the bisecting plane. Thus, a 180° (altitude)×360° (azimuth) field of view (FOV) is captured by the camera. In the current embodiment, a lens is used, as was noted, that permits an even greater FOV, such that we capture a 210°×360° FOV. As previously mentioned, different lenses may capture different field of views.

The camera contains an imaging sensor, typically a Complementary Metal Oxide Semiconductor (CMOS) device that converts incident light, directed by the camera optics (lens) into electrical potentials. This technology is the heart of most modern digital imaging devices. However, different devices, sensors, and/or components may be utilized. FIG. 2A describes two scenarios for capturing panoramas. The CMOS sensor (230) is typically 16:9—the aspect ratio of broadcast as well as “smart” TVs and monitors. There are, however, sensors that are 4:3 aspect ratio, and even square (1:1) aspect ratio. Additionally, as technology improves or changes, different aspect ratios may become more prevalent. The CMOS contains an array of regular pixels arranged in rows and columns, the product of which is called the sensor resolution. A High Definition (HD) video sensor has 1080 (vertical)×1920 (horizontal) pixels, resulting in a resolution of ˜2 million pixels (2MP). One embodiment utilizes a 4k sensor with 3840×2160 pixels.

Most lenses are radially symmetric, and thus produce image circles, whether complete or truncated, on the sensor plane. If the image circle (240) formed by the optics falls completely within the sensor area, then the entire FOV will be captured. If, however, the optics create an image circle that exceeds the sensor's area (250), the FOV in one direction will be truncated. In the present embodiment, the camera is positioned such that the horizontal FOV aligns with left/right on the playing field so as to capture the widest FOV (i.e., capturing the sidelines). Up/down is aligned with the vertical dimension of the sensor. Clearly, one can see that areas outside the image circle (240, 250) are essentially wasted in that they contain no information from the scene. Ideally, the system attempts to maximize the number of active pixels recruited, even at the expense of loss of vertical FOV. Naturally, an anamorphic lens may be employed which is not radially symmetric. In this case, the image circle is transformed into an image ellipse which can better recruit the sensor pixels.

Along these lines, as discussed in connection with FIG. 8-FIG. 10, due to the location of the camera lens within the pylon, the pylon includes a cutout that allows the lens to capture the full FOV horizontally. The system described in connection with these figures illustrates the cutout in the horizontal plane in order to increase information from the scene that is captured in a horizontal plane. However, in some applications it may be equally or more useful to capture a wider FOV in the vertical direction. Thus, the cutout may alternatively, or additionally, be provided in a vertical direction to allow the lens to capture a wider FOV in the vertical plane than what might be provided without a cutout in the vertical direction.

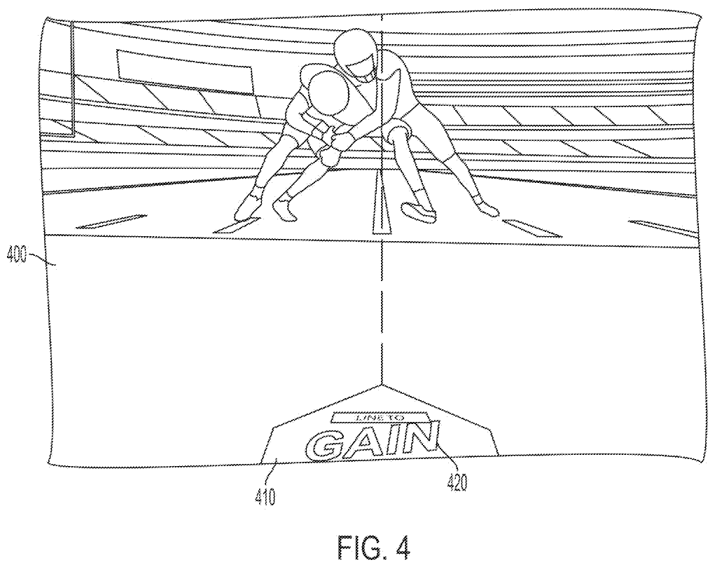

Using the illustration of FIG. 4, the method and process of capturing wide FOV video images and augmenting with real-time fiducials is described. The augmentation occurs as the video is being captured, processed, and streamed to one or more users in substantially real-time. In other words, the augmentation occurs as a user or users are watching the “live” broadcast. However, it should be understood that the described system and method can also be applied to video that was previously captured and recorded and is being broadcast or viewed at a later time. For ease of understanding, a singular video frame (400) is shown. However, it should be understood that the described method is applied to many video frames and is frequently applied while the video frames are being captured and streamed.

The following example is merely an example process for capturing and processing video frames. Other processes may be utilized, particularly as technology changes. The illustrated video frame is an HD (1920×1080) resolution “still” from a video sequence showing a near sideline play. The camera and lens (100) capture substantially a hemisphere of information (230/240) at a frame rate of 60 Hz with a significantly higher resolution of 3840×2160. These frames are sequentially encoded by an embedded processor (120). Synchronously captured sensor (110) information is stored as metadata with each video frame, and then pushed to the wireless transmitter (130) for relay to the operator/production workstation (170) where it is ingested. The bit rate at which the signal is transferred directly correlates with the quality of the received signal. In a non-limiting embodiment, the HEVC (H.265) codec, which can provide lossy 1000:1 compression, is employed. Other codecs, including inter-frame, or mezzanine compression codecs such SMPTE RDD35, providing lower compression ratios of 4:1, may be employed. Practically, the choice of codec is determined by the available transmission bandwidth, as well as the encoding/decoding latency, and power, and resolution requirements. Once the encoded video is received and buffered, it is then decoded. This may be performed on the GPU (175) due to its integral hardware decoder, or it may be performed on an external bespoke decoding appliance. In the preferred case of GPU decoding, once each video frame is decoded, it is immediately available in GPU memory for subsequent video pipeline processing.

It should be noted that for simplifying the description of this invention, several of the video pipeline stages have been omitted for clarity, including, flat-field correction, color corrections, image sharpening, dark-field subtraction, and the like.

At this point, the system has created and stored a decoded video frame, along with its concomitant sensor-rich metadata, in GPU memory. When drawing fiducials or other graphics that are to appear in the production video, the system employs a 3D spherical (200) model as is shown in FIG. 2A. Prior to outputting video frames to the backhaul (180), however, the video frames are typically converted from the spherical model space into a rectilinear space suitable for 2D viewing. FIG. 2B illustrates an exemplary captured video frame using the image capture principles illustrated in FIG. 2A. FIG. 2B shows the sensor area (230), as well as the image circle section on the sensor. As described earlier, the example shown in FIG. 2B has a 210° horizontal FOV, whereas the vertical FOV is truncated due to the fact that the image circle is not completely formed on the sensor. In comparing the video frame in FIG. 2B to that in FIG. 4, it can be seen that the image in FIG. 2B is distorted. Due to the extreme wide angles captured with the short focal length “fisheye” lens, the individual video frames must undergo a rectification process, also known as “de-warping.” This results in video frames with the correct, and natural, perspective. Each lens must be calibrated so as to characterize the fisheye distortion function.

The proposed family of augmented reality graphics leverages the fact that the camera is capturing partial 3D video. The video is partial 3D in the sense that only directional component is present with no native depth information, although some depth information can often be inferred. For example, we know a priori the approximate height of a football player, so we are able to infer the distance from the camera. Assuming the physical camera is stationary and the feed is viewed on a non-stereoscopic display, as is typical, then convincing 2D or 3D graphics can be placed almost anywhere in the scene with little to no additional hardware, providing a resulting image that appears much like an image utilizing a traditional chromakeying system. In other words, the described system is able to add graphics or fiducials to a video stream that is broadcast, accessed, or otherwise viewed by a viewer or other user. However, it should be noted that the described system and method provides images benefits that are not found in the traditional chromakeying system, for example, more accurate fiducials and/or graphic placement, minimization of image effects caused by similarities between the color of the “screen” used in chromakeying and objects within the image, and the like.

The degree of difficulty of such graphic placements depends on which actual scene entities the graphic is desired to appear between. For example, graphics that are meant to appear directly between the camera and the scene such as the Line to Gain marker, telestrations, or heads-up-display style objects can be placed trivially. However, graphics that are intended to appear realistically between dynamic entities such as players and static entities, for example, the stands, field/court, or the like, can be placed with an accurate but potentially simple model of the static entities and chromakey-like techniques. As the 3D video already exists on the system described, the graphics can be rendered into the scene in real time on the hardware described in conjunction with the Figures. Placing graphics between dynamic entities, such that portions of the graphics are occluded, may require a full 3D (multiple camera) capture.

An example process for placing the graphics is described. Using the 3D model concept, the camera feed is a stretched (warped) onto a first sphere. In computer memory, a secondary sphere is created for the purposes of drawing graphics. Using techniques of 3D computer modeling involving texture and fragment shaders, fiducials can be introduced, via graphic primitive call, into the second sphere. At the end of the processing for each frame, the two spheres will be merged or fused, and finally, a 2D video region of interest will be excerpted from the model.

In FIG. 2B, the physical LTG marker (260) is shown. This is an orange fabric marker that is placed by the referees. In FIG. 4, the LTG marker (410) is a digitally augmented fiducial created in the computer model. Control software allows the system to vary the width and length of any overlaid graphics, for example, fiducials, such that it “overlays” the physical LTG on the field. Opacity controls further aid in the adjustment such that the augmented fiducial appears accurately. The digitally augmented LTG marker has the additional benefit of providing useful “real-estate” for the purposes of introducing information, for example, referring to FIG. 4, text (420) reading “LINE TO GAIN” has been illustrated. However, other information may be displayed, or the area could be used for sponsorships, advertisements, and/or the like.

Unlike the physical LTG marker, which exists only on the sidelines as permitted by the league, the digital fiducial can extend in space as shown by the “vertical” line emanating from the point on the marker and continuing upwards through the vertical FOV. Thus, this line is a longitudinal line drawn on the second sphere, initially centered on the plane of the optic axis. Digitally extending the physical fiducial makes it all the more useful in adjudicating referee calls, since it provides a unique visual in spatially and temporally discerning ball, hands, and foot associations as the play transpires.

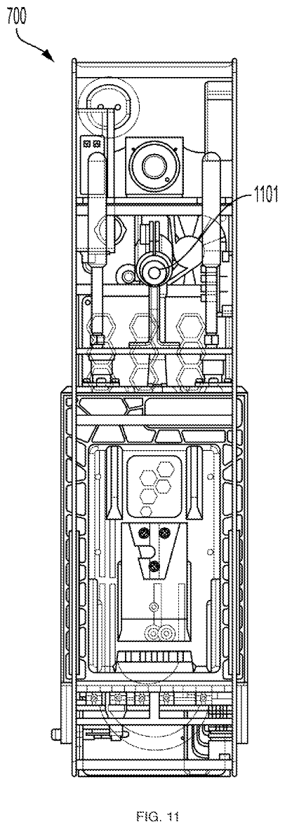

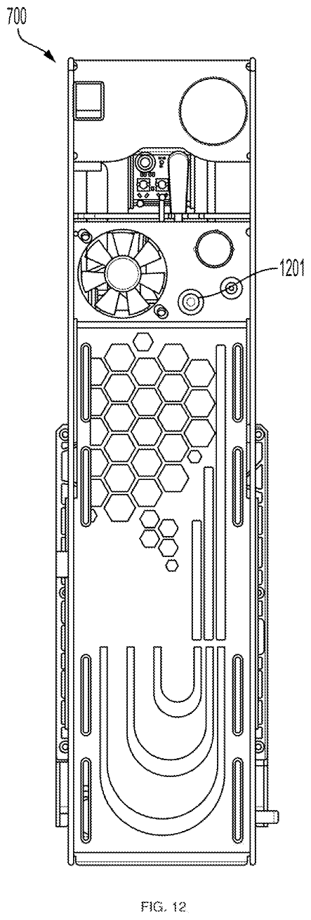

Additionally, using the physical laser line as previously mentioned, the system can verify the placement of the fiducials or other graphics. The physical laser, illustrated in FIG. 11 at 1101, may be located within or connected to a pylon. In the case that the pylons are movable, meaning they are purposely moved throughout the event, the physical laser may be activated by the person or user who is moving the pylon. FIG. 11 illustrates an example interior view of the pylon 700. This activation may be through the use of a button, switch, toggle, and/or any other input device, either mechanical or activated using a different input modality, for example, gesture, audio, and/or the like. For example, the activation switch may be a motion activated switch where the user simply waves their hand over the switch, thereby activating the laser. As another example, the activation switch may be light sensitive switch where blocking light to the switch activates or deactivates the laser. As a final, non-limiting example, the activation switch may be a momentary switch, for example, as illustrated in FIG. 12 at 1201, that activates the physical laser line as long as pressure is being applied to the switch/button. As soon as pressure is removed, the physical laser line is deactivated. Thus, the physical laser line is only active as long as pressure is being applied to the switch.

Upon activating the laser line, not only can the pylons be lined up with the target location, whether that is an object within the sporting event, markings on the sporting event surface, and/or the like, but the described system can also detect the laser line and then use the laser line to ensure that the fiducial and/or graphics are corrected placed within the video stream. In other words, the laser line can be used by the system to ensure the correct placement of the fiducials within the video stream. In one embodiment, the system may compare the placement of the fiducials with the physical laser line and make any necessary adjustments if the system determines that the fiducials do not line up with the laser line. In this example, the fiducials may already be placed within the model and the position then compared with the laser line. Alternatively, the system may utilize the laser line as the starting point for placement of the fiducial. In other words, the fiducials may be lined up with the laser line when the fiducial is first placed rather than after the fiducial has initially been placed.

In one embodiment of the invention, the control of the LTG fiducial is actively provided to the computer (170) operator. This is done on a play-by-play basis. For example, if the physical LTG pylon were not oriented perfectly-whether rotated or tilted backwards/forwards-then the operator would be able to adjust the rotation (yaw) and tilt (pitch) via controls provided in the software for changing those angles of the second sphere on which the graphics are drawn.

In a second embodiment of the invention, active, automatic control of the fiducial is accomplished by using the information from the sensor array (110). In a non-limiting example, the 3-axis accelerometer data from the pylon (100) can determine the orientation of the pylon with respect to the playing field. Using this information, the second sphere can be rotated along its three degrees of freedom to compensate. Thus, as the pylon is moved and repositioned, the software will continuously adjust the fiducial, via a feedback loop, much like a bubble level or gyroscope.

In placing the fiducials, or other graphics, the described system and method may make use of historical placement information and/or one or more artificial intelligence models. Additionally, this information may also be used in placing the graphics with respect to other objects within the scene. Since similar fiducials and/or graphics may be placed in different video streams, the systems may at least partially rely on historical placement information. The historical placement information may identify different information about how different graphics were placed, where the graphics were placed, how the graphics were adjusted to be placed, any other adjustments that were made to the graphics or captured scene for graphic placement, and/or the like. For example, in a case where graphics were placed behind moving objects (e.g., players, referees, football, soccer, spectators, etc.), the system may identify what processes needed to be performed or what adjustments needed to be made to the graphics or scene to place these graphics. This information can inform the system regarding what might need to be done to perform a similar operation, even if it is different graphics and a different scene. Such historical information may also be utilized to determine how to properly line up fiducials with markers or objects within the scene.

One or more artificial intelligence models may also be utilized in preparing and placing graphics within a scene and how the graphics and/or scene need to be prepared in order to correctly position and place the graphics. The artificial intelligence model(s) may also be used to determine how to properly line up fiducials with markers or objects within the scene. For ease of readability, the majority of the description will refer to a single artificial intelligence model. However, it should be noted that an ensemble of artificial intelligence models or multiple artificial intelligence models may be utilized. Additionally, the term artificial intelligence model within this application encompasses neural networks, machine-learning models, deep learning models, artificial intelligence models or systems, and/or any other type of computer learning algorithm or artificial intelligence model that may be currently utilized or created in the future.

The artificial intelligence model may be a pre-trained model that is fine-tuned for the described system or may be a model that is created from scratch. Since the described system is used in conjunction with placing graphics within a scene for a video stream, some models that may be utilized by the system are image analysis models, object identification models, text analysis models, and/or the like. The model may be trained using one or more training datasets. Additionally, as the model is deployed, it may receive feedback to become more accurate over time. The feedback may be automatically ingested by the model as it is deployed. For example, as the model is used to place graphics within a scene for a video stream, if a user or technician modifies the placement of the graphic, or otherwise provides some indication that the predictions or selections made by the model may be incorrect, the model ingests this feedback to refine the model.

On the other hand, as the model places graphics within a scene and adjusts the characteristics of the graphic based upon the placement of the graphic with respect to the other objects, and no changes are made to the graphic placement and/or position, the model may utilize this as feedback to further refine the model. Training the model may be performed in one of any number of ways including, but not limited to, supervised learning, unsupervised learning, semi-supervised learning, training/validation/testing learning, and/or the like.

As previously mentioned, an ensemble of models or multiple models may also be utilized. Some example models that may be utilized are variational autoencoders, generative adversarial networks, recurrent neural network, convolutional neural network, deep neural network, autoencoders, random forest, decision tree, gradient boosting machine, extreme gradient boosting, multimodal machine learning, unsupervised learning models, deep learning models, transformer models, inference models, and/or the like, including models that may be developed in the future. The chosen model structure may be dependent on the particular task that will be performed with that model.

The model(s) may be used in conjunction with other manual or automatic placement of graphics within a scene. In one example, the model may be used to initially place the graphic within a scene and a user may then adjust the graphic placement. As another example, a graphic may be placed using a different automatic placement technique, and the model may be used to adjust the positioning of the graphic. Techniques may also be used in conjunction with each other. For example, one technique may be used to position the graphic within the scene and another technique may be used to position the graphic with respect to other objects, for example, behind other objects within the scene, on top of other objects within the scene, and/or the like. For example, when used in conjunction with the physical laser line, the model can utilize the physical laser line to assist in the placing and positioning of the graphic within the scene. The model can receive identification of the location of the physical laser line and use this information to position the graphic with respect to the physical laser line.

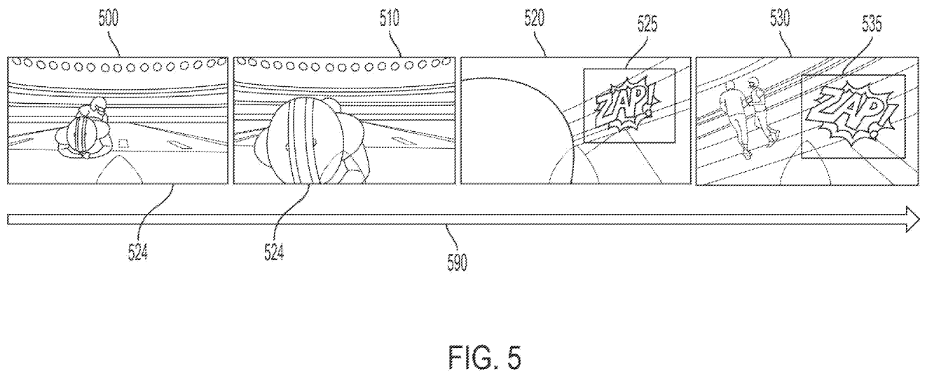

Additionally, the sensor (110) information can be used to enhance the broadcast in other interesting manners. It is common during the course of play for the pylons to be translated from their proper orientation, typically by a collision from one or more players. Such a scenario is shown in FIG. 5. This figure shows a succession of non-contiguous video frames (500, 510, 520, 530) leading to a player colliding with the pylon. The progression of time (590) is shown moving from left to right. Since frames are being acquired at 60 Hz, most of the video sequence is not shown, but it should be understood that the graphics that are injected on a frame-by-frame basis, such that animations may be achieved. In frame 500 the player with the ball is approaching the pylon head-on, in frame 510 the player is about 14″ away from the pylon, frame 520 shows imminent contact, and frame 530 shows the pylon displaced by the collision. Using the sensor array (110), the proximity of the player can be determined by an inexpensive ultrasonic detector coupled to the embedded system (120). At that instance, a graphic highlighted in 525 may be shown, which enlarges and translates (535) as the collision occurs. An accelerometer may be used as well to determine the positional translation during the collision, or to even compute the forces involved.

This is merely one non-limiting embodiment that demonstrates the vast potential for augmenting the live events with autonomous graphic insertion. Additionally, with the information that is captured from the pylon, other actions may be performed. For example, using the captured video feed and the wide field of view, the point of view from the camera could be changed using a computational technique called neural radiance fields (NERF)/Gaussian Splatting. While there are some conventional systems that perform this point-of-view changing, these systems rely on information captured from multiple cameras located at different locations. Using the described system, on the other hand, this point-of-view changing can be performed using information captured by a single camera.

Since the camera captures a wider field of view than the streamed image, the captured image contains more information than what is streamed or within the final view. Using this additional captured information, the system can generate other images or views, specifically images or views having a different point-of-view than the initial final view. With the generated images having different points-of-view, the system can provide these different points-of-view for different applications. In one application, the system can provide a replay that includes the different points of view. In other words, a user watching a replay can change the point of view that is displayed during the replay, thereby allowing the user to see different angles of the captured view. Thus, the system can provide replay controls that all the camera to digitally translate the point-of-view to provide a different view to a replay user. As can be understood, this same idea can be utilized in different applications other than during replays. For example, on a video screen different views can be provided, viewers watching a video stream can provide input to change the point of view shown, and/or the like.

As could be understood, the wider the field of view that is captured by the camera, the more point-of-view images that can be created. Additionally, the system may utilize image analysis techniques and image generation techniques to fill in information that may be missing from images that are captured by the camera. This can be utilized to widen the field of view or provide additional point-of-view images that were not initially captured. Filling in image information or generating new images for different points-of-view can be performed using different image analysis and image generation techniques. Additionally, the system may utilized one or more artificial intelligence models to assist in generating these images. Thus, the point-of-view changing can also be performed utilizing one or more artificial intelligence models. The models may be similar to those previously described with respect to the graphic placement. However, instead of being trained on graphic placement and used in placing graphics, these models would be trained on image reconstruction utilizing captured images to build a new image or point-of-view from the captured images. Thus, the models utilized in this process may be different types of models, but may be trained and refined in a manner similar to that which was previously discussed.

It should be noted that the graphic may be pre-designed, such as a PNG or JPEG graphic, or it may be composed in real time. Video frames of 60 Hz allow for computer operations to be performed that can be completed in <16.67 ms—the inter frame interval. Modern GPUs are capable of thousands of operations per millisecond. More than one graphic may be inserted, as well as changes to video rendering itself, such as composited views shown as a picture-in-picture. This would be feasible if the camera captured not only the collision, or some other notable play, as well as side-line action from others players or the coaching staff.

In a second non-limiting embodiment, the distance between a player and the pylon camera may be written graphically on the successive video frames as is shown by 524. One can see that as the player approaches the pylon, which is stationary during the course of each play, the distance decreases. As discussed above, the proximity-sensing information may come from either proximity sensor (110) embedded in the pylon (150) or via external tracking information as is taught in applicant's previous patent(s)—Object tracking and Data Aggregation in Panoramic Video. In this embodiment, each player or object on the field of play (e.g. ball) is equipped with one or more tracking devices, such that their position relative to each other and the playing field is captured in real-time as a serialization of Euclidean coordinates. Typically, this data, in the form of a UDP “blast” or stream, is ingested at the operator workstation (170) via a TCP/IP connection from the purveyor's server. This data is frame-synchronized with each of the broadcast cameras, including the pylon cameras. In this way, real-time continuous measurements may be made between any or all of the pylons and any or all of the tracked objects.

Other non-limiting embodiments include thumbs up/thumbs down for overturning plays, inserting advertisements, such as “this collision brought to you by Brand Name”, or the like. Augmentation is not limited to graphics, but may also include audio. Typically, audio production occurs synchronously yet independently from the camera production. This is to allow for commentators, and the like, to discuss the game, while local point of view cameras contribute to a distinct field effects audio channel(s) that is intermixed with the commentator contribution channel(s). Thus, in one embodiment, audio “bites” may be triggered by action on the field, sensor input, or by the operator.

As discussed, the model consists of two 3D spheres-one containing the video textures and the second being used for real-time graphics. On a frame-by-frame basis, these two models are “fused” with the video textures being drawn first, at a lower Z-level, and the secondary sphere graphics being drawn over the first, at a higher Z-level. As discussed above, a 2D rectified (de-warped) region of interest is excerpted from this model, then converted to a broadcast (SDI) frame for injection into the backhaul (180). This region of interest is determined both by the operator, or called for by the producer, in response to game action. The software allows for arbitrary pan, tilt, and digital zoom within the 3D composite model space, any of which may be excerpted in real-time or via replay, for push to the backhaul (180) as is taught in the author's previous patents. It may be, for the purposes of officiating, that certain “lockdown” views are employed. For example, two virtual camera views-one looking up the sideline, and the other looking oppositely down the sideline—may be created. In the current embodiment, the software is capable of four virtual cameras (VCAMs) that may or may not be physically output via SDI to the backhaul (180).

Referring again to FIG. 1, the workstation (170) GPU (175) is capable of Artificial Intelligence (AI) inferences. For example, a Deep Neural Network (DNN) may be trained, by ingesting numerous events, to make inferences about what is expected to transpire during a play. In this way, an AI software agent may be used to replace a physical person or persons tasked with creating replay video clips. These inferences may be made based upon both the video frames (and their content), as well as input from the sensor array. Thus, in one embodiment, a plurality of AI agents build the replay clips with no input or interaction from a human operator.

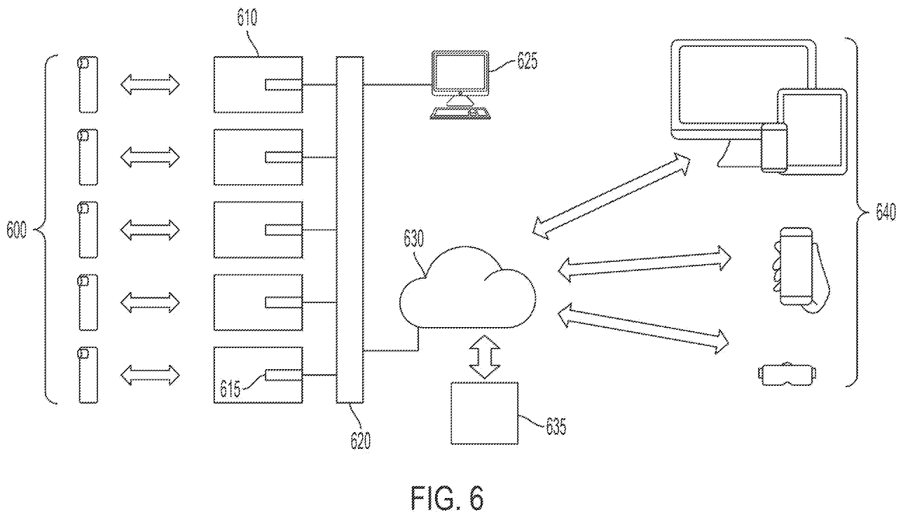

In addition to pushing content to the linear backhaul (180), the video may be streamed for OTT (Over the Top) consumption via a web-based video player, app, or “smart” TV. Referring to FIG. 6, we provide a non-limiting embodiment of the components involved. It should be understood that many details are omitted in order to provide clarity in describing the invention claimed in this disclosure. The plurality of cameras is shown (600), connected to workstations (610), each equipped with a Network Interface Card (NIC), which is in turn connected to a router (620), through which the internet (630) is accessed. A single operator console (625) may be used to access one or each of the workstations (610) through a KVM (Keyboard View Mouse) switch. While the workstations are providing replay and live video (SDI) feeds to the backhaul, they may simultaneously provide streaming experiences to many individual “smart” devices (640) connected to the internet. These devices included “smart” TVs, computers, tablets, phones, Virtual Reality (VR) googles, and the like. Unlike the broadcast, where a region of the immersive sphere is de-warped and output in 16:9 aspect ratio in a standard video format such as HD (1920×1080 pixels), the streamed experience contains the entire immersive hemisphere. In this way, each end user may choose their own Pan, Tilt, and Zoom (PTZ) within the context of an immersive player application that runs or is executed on their device.

Typically, a single origin stream is relayed to a Content Distribution Network (CDN) (635) that facilitates the transcoding and distribution of the stream to many users. The end user's application receives an encoded stream from the CDN (635) in a format and bitrate that may differ from the original stream. The stream is then decoded, and the video frames are de-warped using the same algorithm as is used in the broadcast, and then displayed using calls to a graphics API, typically being accelerated by the device's GPU. The user is then free to interact with the immersive video in the same way that a broadcast or replay operator interacts with the pylon camera view. In this manner, the experience of watching a game is personalized. The application may be able to switch from one stream to another, which would allow the user to switch, for example, from camera to camera. The personalization of the OTT immersive experience may also extend to the nature and type of graphics that are inserted into the player application. As with the broadcast video, the OTT stream carries with it, via metadata, the state of all attached sensors, as well as, relevant tracking information, as is taught in applicant's previous patents. In this way, the viewing application may be highly customized for each individual's preference regarding the type of graphics, colors, statistics, notifications, etc. that are displayed.

The present embodiment describes a use case for an American football pylon. Other embodiments include use in hockey and soccer nets, showing fiducials for whether the puck or ball crosses the plane of the goal.

Thus, in one example use case, the system obtains, using at least one image capture device located within a pylon, at least one panoramic image of a scene. In the example, this is a scene of some portion of the American football field and potential objects or people on or surrounding the football field. As understood in the art, a panoramic image is an image that has a wider field of view than a traditional image. Additionally, in the described system and method, a panoramic image may be an image that captures a larger image of the scene than what is included in the broadcast image or view. This capture of the at least one panoramic image can be performed using the camera within the pylon as described further herein. Once the image(s) are captured, they can be sent to a processing device, as also described herein. It is this processing device that obtains the at least one panoramic image of the scene.

The processing device may receive an indication to add a real-time graphic to the at least one panoramic image before the at least one panoramic image is transmitted to an end user, for example, within a broadcast frame or video. The processing device places the real-time graphic onto the at least one panoramic image, for example, utilizing the techniques described herein. The processing device may also verify the placement of the real-time graphic within the at least one panoramic image by comparing a location of the real-time graphic within the image to a location of a physical marker within the scene corresponding to the image. For example, in the use case where a physical laser line can be activated, the system may use the location of the physical laser line to verify the placement of the real-time graphic within the image. It should be noted that the physical laser line may or may not be captured within the image itself. In the case that the physical laser line is captured within the image, the system may simply use the laser line to place the graphic. In the case that the physical laser line is not captured within the image, the system may capture or access additional images or a video feed (from the same or a different image capture device) where the physical laser line may have been included, access a camera that is associated with the physical laser line, access a camera that is currently capturing images of the scene, and/or the like.

Accordingly, the system, device, and/or product may include at least one image capture device, a processor operatively coupled to the at least one image capture device, a memory device, and/or a computer-readable storage device that stores executable code. These devices may also be used in performing the method of obtaining, using at least one image capture device, at least one panoramic image of a scene, receiving an indication to add a real-time graphic to the at least one panoramic image before transmission of the image to an end user, placing the real-time graphic onto the at least one panoramic image, verifying placement of the real-time graphic onto the at least one panoramic image by comparing a location of the real-time graphic within the at least one panoramic image with a location of a physical marker within the scene corresponding to the at least one panoramic image, and generating a broadcast frame from the at least one panoramic image having the real-time graphic, wherein the generating comprises identifying a region of interest within the at least one panoramic image having the real-time graphic and converting the region of interest to the broadcast frame. Additionally, the system and method include adjusting the placement of the real-time graphic responsive to the verifying and also is able to work when the physical marker is not included in the at least one panoramic image.

In another example use case, the system can create new images having different points-of-view as compared to an initial image that was created. As previously mentioned, within a captured panoramic image there is more image information than what is provided within an image that is transmitted to a user. In other words, a panoramic image is generally larger than an end image, whether that is a broadcast image, image presented on a display device, or other image that may be created. Thus, portions of the panoramic image are cut off when generating the end image. This additional image information captured within the panoramic image can be utilized to produce images that have a different point-of-view as compared to this initial end image. Thus, in one use case the system may obtain at least one panoramic image in any of the same methods as previously discussed and from the pylon camera. From this panoramic image, the system generates an image having a defined region of interest. This region of interest corresponds to the portion of the panoramic image that is found in the end image.

The system may then receive an indication to adjust a point-of-view within this initial end image, also referred to as the image, for ease of readability. The indication may be an indication that a different angle of the same image is desired. For example, within a sporting event a referee, spectators, broadcasters, and/or the like, would like to see a replay of a particular play. However, the initially broadcast or end image does not show a desirable angle such that a particular point of contention can be identified, for example, whether a ball hit the ground before being caught, whether a player touched the ground while being touched, whether a ball crossed a goal line or out-of-bounds line, and/or the like. Accordingly, a user may want to see a different angle or point-of-view of the same play in order to better determine whether some event occurred. Using the described system, the user can get this image or replay having the different point-of-view. Thus, upon receipt of the indication to adjust the point-of-view, the system generates a new image with a different point-of-view as compared to the image. This new image can then be transmitted to the user. Generation of the new image can be accomplished using the techniques previously described.

If this technique of changing the point-of-view of an image is performed for multiple images, either consecutive images that are received within a video feed or a set of images which may not be consecutive or even obtained from the same camera, the system can aggregate the point-of-view adjusted images into a video feed. This video feed can then be broadcast or transmitted to a user. Thus, for example, the system can generate an entire replay video that has a series of images with the adjusted point-of-view such that it appears to be a smooth video feed with the adjusted images as if the adjusted point-of-view video is the one that was initially captured even though it was not. Also, the system could combine or aggregate images having the initial point-of-view, images that all have the same adjusted point-of-view, and/or images that have different points-of-view from each other, or a combination thereof. This aggregation of images can then be transmitted to another device, display device, and/or the like as, for example, a video feed, a set of images, and/or the like.

Accordingly, the system, device, and/or product may include at least one image capture device, a processor operatively coupled to the at least one image capture device, a memory device, and/or a computer-readable storage device that stores executable code. These devices may also be used in performing the method of obtaining, using at least one image capture device, at least one panoramic image of a scene, generating an image from the at least one panoramic image, wherein the generating comprises identifying a region of interest within the at least one panoramic image and converting the region of interest to the image, receiving an indication to adjust a point-of-view of the image, generating, from the at least one panoramic image, a new image with a different point-of-view as compared to the image, and transmitting the new image with a different point-of-view to a user.

Additionally, the system and method include aggregating the image and the new image with a different point-of-view into a video feed and transmitting the video feed to a display device. Additionally, the system and method may perform the adjusting for a series of consecutive at least one panoramic images captured using the at least one image capture device. The system and method may then include generating a video feed comprising the series of consecutive at least one panoramic images that have been adjusted. Additionally, when generating the new image, the system and method may utilize a computational technique to digitally translate the point-of-view within the at least one panoramic image and or infer and fill, utilizing an image analysis and image generation technique, portions of the new image with information not captured within the at least one panoramic image.

The pylon may include a body that has different faces. For example, the pylon may be a rectangular prism shape and have four faces, a front face, a back face, and two side faces. However, other shapes are contemplated and possible, for example, a triangular prism shape, a cylindrical shape, an octagonal prism, a hexagonal prism, and/or the like. In the case of the cylindrical shape, there may only be a single face, but the pylon may still have an arbitrary front and back. The shape, and faces of the pylon, may create an internal cavity where electronics and other components can be placed. In order to create this internal cavity, the body of the pylon may be created using some material that allows for creation of the structure. For example, the pylon may have a skeleton of sources that give the pylon its shape. This skeleton may be made of lightweight, but structurally strong material, for example, plastic, metal, and/or the like. The pylon body may have an outer covering that provides some protection to the internal components and also makes it so that if someone hits the pylon, the person will not be injured by the pylon. Thus, the outer covering may include padding, a lightweight material, and/or the like.

The pylon may include a cutout. This cutout is within the body of the pylon, thereby creating an indent or recess within the body of the pylon. The size and shape of the cutout may allow the lens to capture the scene instead of the inside of the pylon. In other words, since the lens of the pylon captures a panoramic view, the cutout is included in order to let the lens obtain the panoramic view of the scene instead of being blocked by a portion of the pylon body. Thus, the cutout may extend from the outside plane of the body face towards the internal portion of the pylon. The cutout may stop at the lens of the camera. Thus, the lens of the camera will be inset from the outer face of the body of the pylon, thereby providing some protection to the lens. From a vertical and horizontal perspective with respect to the lens, the cutout may extend up and down and left and right from the lens. In order to accurately capture the wide field of view of the lens, the cutout may need to be larger towards the outer edges of the cutout as compared to the inner portion of the cutout closest to the lens. Thus, the cutout may end up having a bow-tie type shape. However, other shapes are contemplated and possible and may vary based upon the type of lens and the field of view of the lens that is utilized within the pylon.

Accordingly, the pylon may include a body comprising a plurality of faces creating an internal cavity, a cutout within one of the plurality of faces, wherein the cutout is indented from the plane of the outer portion of the one of the plurality of faces, an image capture device located within the internal cavity; and a lens coupled to the image capture device and positioned within the cutout, wherein the lens comprises a wide field of view lens, wherein a shape and size of the cutout allows for capture of the wide field of view obtainable by the lens. Such an example pylon is illustrated in FIGS. 6-12. Other characteristics of the pylon are described in more detail here throughout.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, a system, apparatus, or device (e.g., an electronic, magnetic, optical, electromagnetic, infrared, or semiconductor system, apparatus, or device) or any suitable combination of the foregoing. More specific examples of a storage device/medium include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and “non-transitory” includes all media except signal media.

Program code embodied on a storage medium may be transmitted using any appropriate medium, including but not limited to wireless, wireline, optical fiber cable, RF, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices and program products according to various example embodiments. It will be understood that the actions and functionality may be implemented at least in part by program instructions. These program instructions may be provided to a processor of a device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method, comprising:
obtaining, using at least one image capture device, at least one panoramic image of a scene;
receiving an indication to add a real-time graphic to the at least one panoramic image before transmission of the at least one panoramic image to an end user;
placing the real-time graphic onto the at least one panoramic image;
verifying placement of the real-time graphic onto the at least one panoramic image by comparing a location of the real-time graphic within the at least one panoramic image with a location of a physical marker within the scene corresponding to the at least one panoramic image; and
generating a broadcast frame from the at least one panoramic image having the real-time graphic, wherein the generating comprises identifying a region of interest within the at least one panoramic image having the real-time graphic and converting the region of interest to the broadcast frame.

2. The method of claim 1, wherein the placing comprises:
generating a first sphere from the at least one panoramic image;
generating a second sphere, wherein the generating a second sphere comprises adding the real-time graphic into the second sphere; and
generating a single model by fusing the first sphere with the second sphere having the real-time graphic.

3. The method of claim 1, comprising adjusting the placement of the real-time graphic responsive to the verifying.

4. The method of claim 1, wherein the physical marker is not included in the at least one panoramic image.

5. The method of claim 1, wherein the obtaining comprises obtaining metadata with the at least one panoramic image.

6. The method of claim 1, wherein the obtaining comprises obtaining a plurality of panoramic images and generating, from the plurality of panoramic image, a full three-dimensional image.

7. The method of claim 1, wherein the placing the real-time graphic comprises placing the real-time graphic between dynamic entities within the at least one panoramic image.

8. The method of claim 1, wherein the adding the real-time graphic comprises adjusting at least one characteristic of the real-time graphic before placement within the at least one panoramic image.

9. The method of claim 1, wherein the real-time graphic is derived from information captured by one or more sensors.

10. The method of claim 1, wherein excerpted region of interest comprises a two-dimensional rectified region of interest.

11. A system, comprising:
at least one image capture device;
a processor operatively coupled to the at least one image capture device;
a memory device that stores instructions that, when executed by the processor, cause the information handling device to:
obtain, using the at least one image capture device, at least one panoramic image of a scene;
receive an indication to add a real-time graphic to the at least one panoramic image before transmission of the at least one panoramic image to an end user;
place the real-time graphic onto the at least one panoramic image;
verify placement of the real-time graphic onto the at least one panoramic image by comparing a location of the real-time graphic within the at least one panoramic image with a location of a physical marker within the scene corresponding to the at least one panoramic image; and
generate a broadcast frame from the at least one panoramic image having the real-time graphic, wherein the generating comprises identifying a region of interest within the at least one panoramic image having the real-time graphic and converting the region of interest to the broadcast frame.

12. The system of claim 11, wherein the placing comprises:
generating a first sphere from the at least one panoramic image;
generating a second sphere, wherein the generating a second sphere comprises adding the real-time graphic into the second sphere; and
generating a single model by fusing the first sphere with the second sphere having the real-time graphic.

13. The system of claim 11, comprising adjusting the placement of the real-time graphic responsive to the verifying.

14. The system of claim 11, wherein the physical marker is not included in the at least one panoramic image.

15. The system of claim 11, wherein the obtaining comprises obtaining metadata with the at least one panoramic image.

16. The system of claim 11, wherein the obtaining comprises obtaining a plurality of panoramic images and generating, from the plurality of panoramic image, a full three-dimensional image.

17. The system of claim 11, wherein the placing the real-time graphic comprises placing the real-time graphic between dynamic entities within the at least one panoramic image.

18. The system of claim 11, wherein the adding the real-time graphic comprises adjusting at least one characteristic of the real-time graphic before placement within the at least one panoramic image.

19. The system of claim 11, wherein the real-time graphic is derived from information captured by one or more sensors.

20. A product, comprising:
a computer-readable storage device that stores executable code that, when executed by a processor, causes the product to:
obtain, using at least one image capture device, at least one panoramic image of a scene;
receive an indication to add a real-time graphic to the at least one panoramic image before transmission of the at least one panoramic image to an end user;
place the real-time graphic onto the at least one panoramic image;
verify placement of the real-time graphic onto the at least one panoramic image by comparing a location of the real-time graphic within the at least one panoramic image with a location of a physical marker within the scene corresponding to the at least one panoramic image; and
generate a broadcast frame from the at least one panoramic image having the real-time graphic, wherein the generating comprises identifying a region of interest within the at least one panoramic image having the real-time graphic and converting the region of interest to the broadcast frame.
